(19) United States
(12) Patent Application Publication
(10) Pub. No.: US 2017/0094948 A1
(43) Pub. Date: Apr. 6, 2017

(54) Comprehensive System of Herd Management with Automated Data Management

(71) Applicant: Joseph Massey, San Antonio, TX (US)

(72) Inventor: Joseph Massey, San Antonio, TX (US)

(21) Appl. No.: 14/876,341

(22) Filed: Oct. 6, 2015

(51) Int. Cl. A01K 29/00; G06F 17/30

(52) U.S. Cl. CPC A01K 29/005; G06F 17/30557

(57) ABSTRACT

The present invention is a comprehensive herd management system that provides automated data gathering, storing, synchronization, backup, and analysis as well as integration with wireless instrumentation, utilizes automated data input methods, and a mobile device application to provide herd management, breed registry, and herd performance data from birth to slaughter.

### BACKGROUND OF THE INVENTION

1. Field of the Invention

The present invention relates to beef cattle herd management software, particularly to a mobile device app or computer program that records and banks cattle data including genetic information, customer and supplier history, animal performance tracking, and custom reports, as well as interfaces with existing herd management programs and integrates with accounts receivable programs.

2. Description of Related Art

Herd management software is a field of computer programs developed to electronically store and manage livestock records. Cattle producers keep records on their herd, including performance data, herd inventory, progeny histories, health, breeding, calving, expenses, sales, and customer contacts. This data is valuable for making management and marketing decisions, and it is convenient and easier to access the data when it is stored electronically.

However, existing herd management software has several disadvantages, including requiring the entry of data at a computer. In effect this requires the herd manager to keep paper notes while performing tasks in the field and then enter the data from those notes when at a computer terminal. This results in additional time, costs, and data transcription errors. These disadvantages become magnified in the consumer marketplace where consumers desire a single app that is accessible across devices and can merge the features of traditional herd management software and breed registry information, all with the convenience of little to no manual data entry.

### SUMMARY OF THE INVENTION

The innovation of the present invention is combines the concepts of herd management software with breed registry to create a comprehensive beef management program. The invention further automates herd management by interfacing with wireless devices such as RFID tags, scales, and other herd instruments to gather and store data. The invention allows a manual setting of additional information to be stored with each data point received wirelessly. For example, a user can set up a schedule of vaccination shots to be recorded along with the weight of the herd animal. The weight is received via a wireless scale. The particular herd animal is identified via a RFID tag and the vaccination schedule is administered by a vet while the animal is in the scale pen. All of this information is collected and collated automatically without any human intervention other than setting up the initial vaccination or other data fields. The invention synchronizes the data seamlessly between a mobile device, the cloud, and desktop access stations and is comprehensive from animal birth to slaughter.

### BRIEF DESCRIPTION OF THE FIGURES

A better understanding of the business method and system of the present invention may be had from the figures as described in greater detail in the DETAILED DESCRIPTION OF PREFERRED EMBODIMENT section which follows:

FIG. 1 is a screen shot of the “Home Screen” of the preferred embodiment of the present invention;

FIG. 2 is a screen shot of the “Herd Inventory” screen of the preferred embodiment of the present invention;

FIG. 3 is a screen shot of the “Animal Details” screen of the preferred embodiment of the present invention;

FIG. 4 is a screen shot of the “Calving History Report” screen of the preferred embodiment of the present invention;

FIG. 5 is a screen shot of the “Health—Vaccinations” screen of the preferred embodiment of the present invention;

FIG. 6 is a screen shot of the “Breeding Female List” screen of the preferred embodiment of the present invention;

FIG. 7 is a screen shot of the “Customer Map” screen of the preferred embodiment of the present invention;

FIG. 8 is a screen shot of the “Bluetooth Devices” screen of the preferred embodiment of the present invention;

FIG. 9 is a screen shot of the “Pasture Inventory” screen of the preferred embodiment of the present invention;

FIG. 10 is a screen shot of the “Record Calf” screen of the preferred embodiment of the present invention;

FIG. 11 is a screen shot of the “Reports” screen of the preferred embodiment of the present invention;

FIG. 12 is a screen shot of the “Work Animal” screen of the preferred embodiment of the present invention;

FIG. 13 is a screen shot of the “Work Animal—Add Weight” screen of the preferred embodiment of the present invention;

FIG. 14 is a screen shot of the “Work Pasture” screen of the preferred embodiment of the present invention.

### DETAILED DESCRIPTION OF PREFERRED EMBODIMENT

The present invention relates to cattle herd management software and mobile applications. It tracks and banks data in one location, combining breed registry information, genetic inventory tracking, customer and supplier history, and pasture to plate performance tracking. The preferred embodiment of the present invention uses the many automated tools available to record and bank data, including EID tag readers and electronic scale programs.

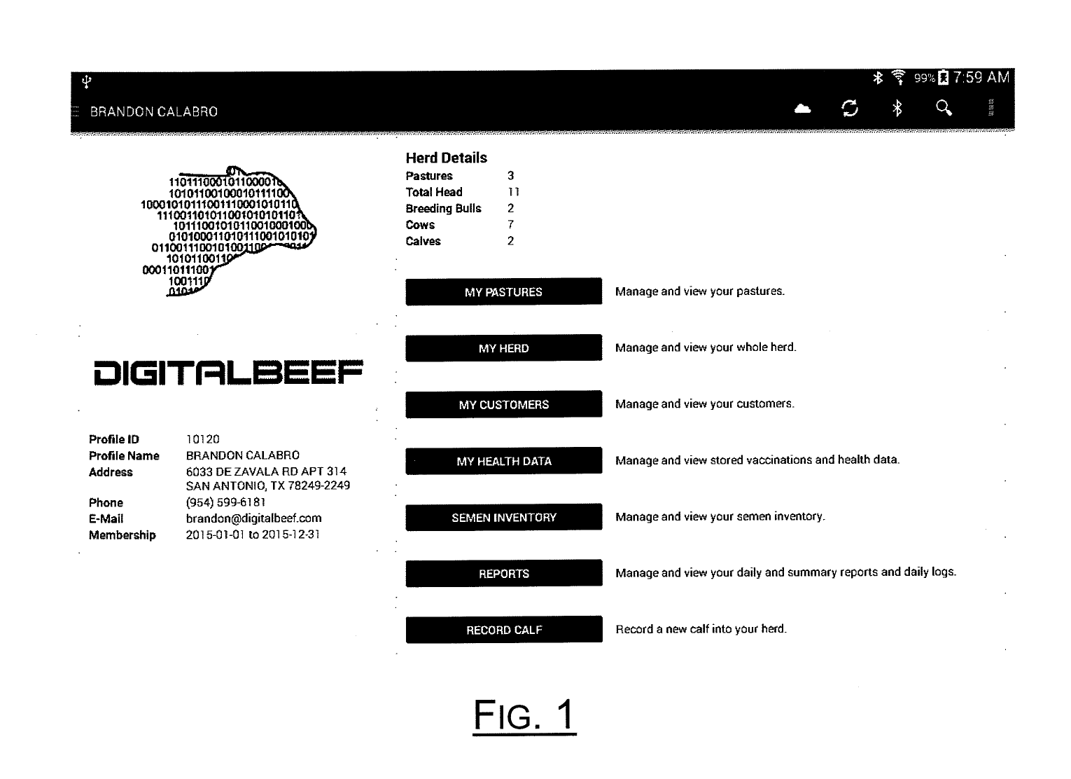

Turning to FIG. 1, the Home Screen of the preferred embodiment shows an overview of the information tracked and banked by the present invention. On the left appears the customer's personal profile information, including profile ID number, name, address, phone number, and email, as well as dates of Digital Beef membership. At the top of the Home Screen is a summary of Herd Details, including number of pastures, total head of cattle, and numbers of bulls, cows, and calves.

The majority of the Home Screen shows links to other screens and features of the present invention. More detailed descriptions of what the customer sees after choosing a button on the Home Screen can be found later in this DETAILED DESCRIPTION OF PREFERRED EMBODIMENT section. The “Pastures” button takes the user to section where pasture information can be viewed and managed. The “My Herd” button takes the user to the section of the preferred embodiment where details about the herd can be viewed and managed. “My Health Data” links the user to the section where they can see data about the health of the herd, as well as vaccination details. The “Semen Inventory” button directs the customer to where they can view and manage semen inventory. In the “Reports” section the customer can manage and view daily summaries and logs relating to the herd. Lastly, the “Record Calf” section is where the user enters data regarding a new calf added to the herd.

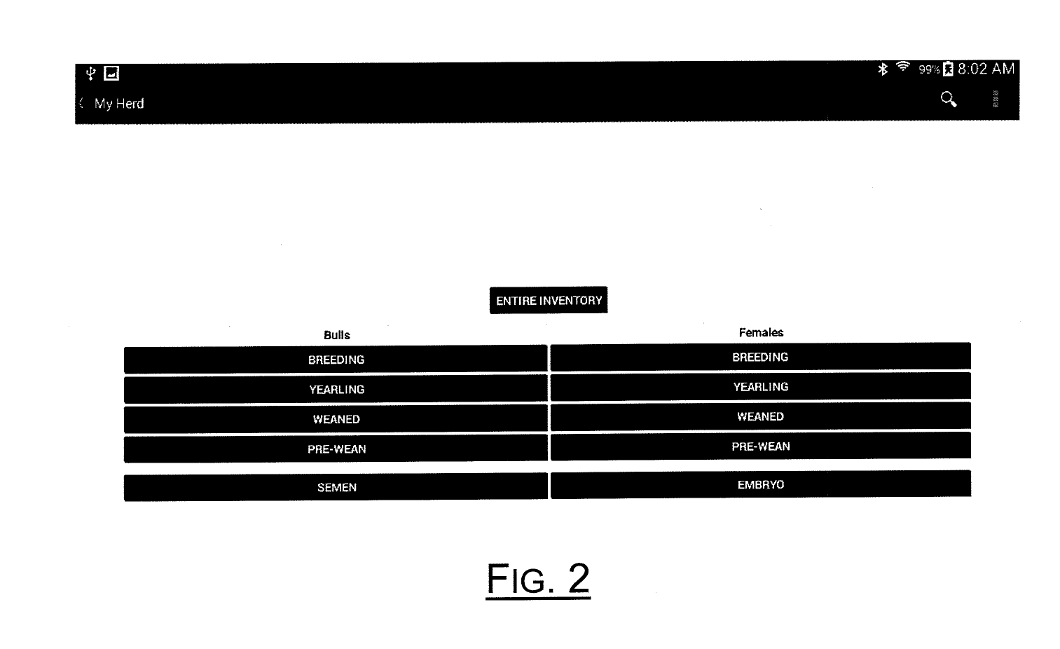

FIG. 2 shows the “Herd Inventory” screen, where customers can view their bull and cow counts at each stage of development. Inventories are divided by gender. Under “Bulls” or “Females,” the customer can choose the “Breeding” button to access data and inventory about cattle of breeding age of each sex. Similarly, the “Yearlings” buttons take the customer to data and inventory about yearling-aged cattle. The “Weaned” buttons show inventory and data about cattle of each sex that are weaned but not yet yearlings, and the “Pre-wean” buttons link to herd inventory information about cattle not yet weaned.

Under the “Bulls” menu, the customer can choose “Semen” to see inventory and data for available semen. Under the “Females” menu, the customer can choose “Embryo” to view inventory of available embryos and their related data.

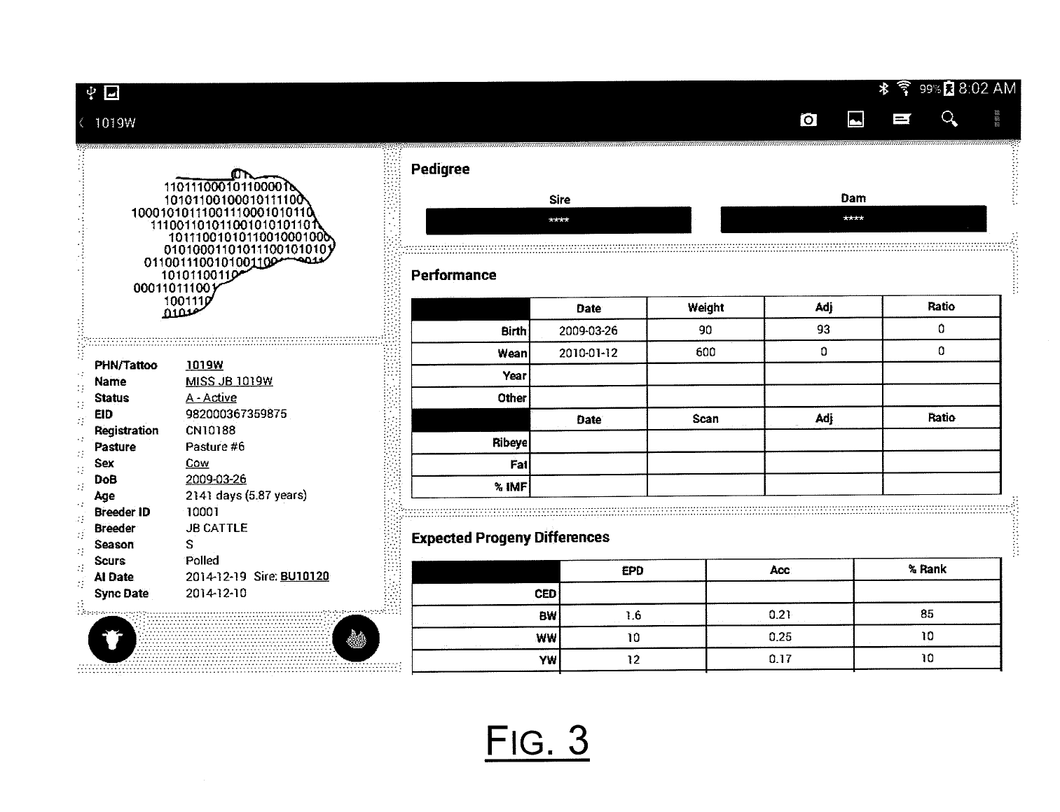

FIG. 3, “Animal Details,” shows the pedigree and statistics for a particular animal in the herd. A link to the animal's sire and dam are available at the top of the screen. On the left is a list of all the animal's information and assigned numbers, including tattoo, electronic identification (EID), and registration number. Also available for quick viewing is the animal's name, gender, assigned pasture, date of birth, current age, breeder, scurs, date of artificial insemination and sire's number, and the date the animal's information was last synced. It includes buttons to navigate to other portions of the software, including herd monument.

The main part of the Animal Details screen shows the animal's Performance Information. The top chart shows the birth date, birth weight, adjusted weight, and the ratio. The next line in the chart shows the date the animal was weaned, the weaning weight, adjusted weight, and ratio. Similarly, the following line indicates the animal's yearling date, weight, adjusted, weight, and ratio. A line of “Other” is included where the customer can indicate a custom time for inputting measurements.

The next portion of the chart is where the customer indicates the bovine's slaughtering potential. There is space to enter measurements of ribeye area, fat thickness, and the percentage of intramuscular fat (IMF). The user can manually enter the date or this information is alternatively automatically entered by the use of wireless devices such as wireless weighing scales.

The bottom chart on the Animal Details screen shot is Expected Progeny Differences (EPD). This chart uses complex algorithms to calculate expected differences in weight and calving ease for the animal's progeny. The first column of the chart shows EPD for calving ease direct (CED), birth weight (BW), weaning weight (WW), and yearling weight (YW). The expected weight differences are expressed in pounds. The “Acc” column shows the accuracy, or reliability, of each measurement of EPD. The “% Rank” column expresses the percentile rank within the herd.

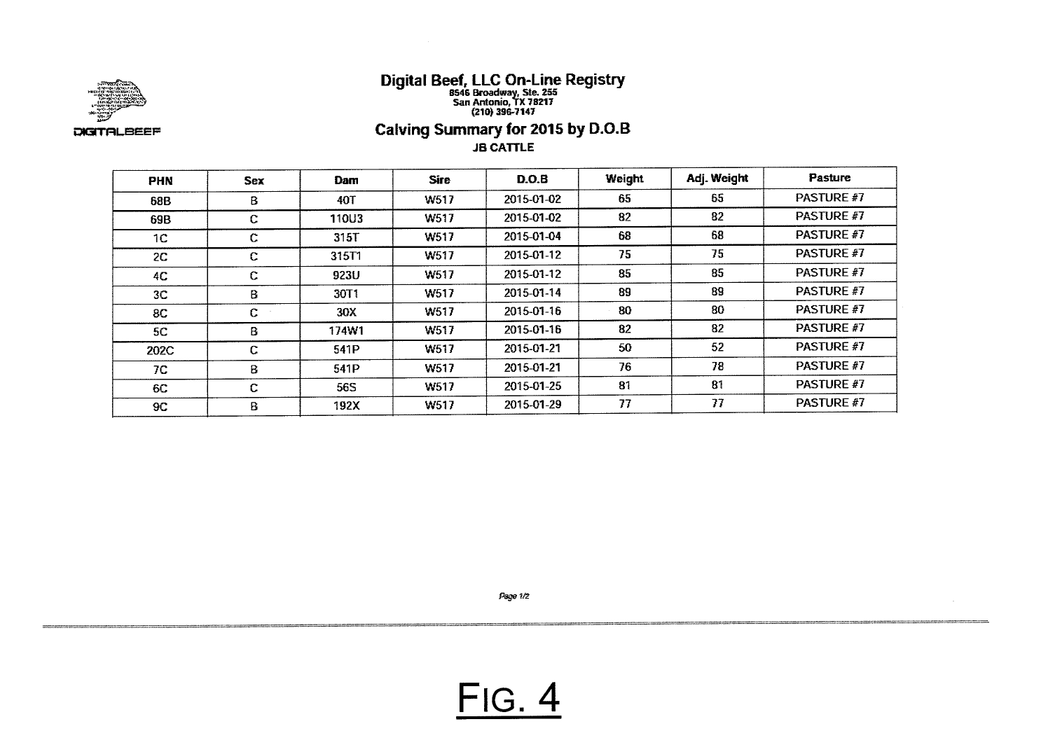

FIG. 4, a screen shot of the “Calving History Report,” shows a summary of data for all the calves born in a given timeframe, in this case the year 2015. It is arranged by birth date. The first column on the chart gives the private herd number (PHN) for each calf. The second column shows the sex of the calf, B for bull and C for cow. The third column gives the calf's dam's identification, and in the fourth column is the sire's identification number. The fifth column gives each calf's date of birth. The sixth column shows the calf's weight at time of birth, and the seventh column shows the calf's adjusted weight. Finally, the eighth and last column shows which pasture the calf is located in.

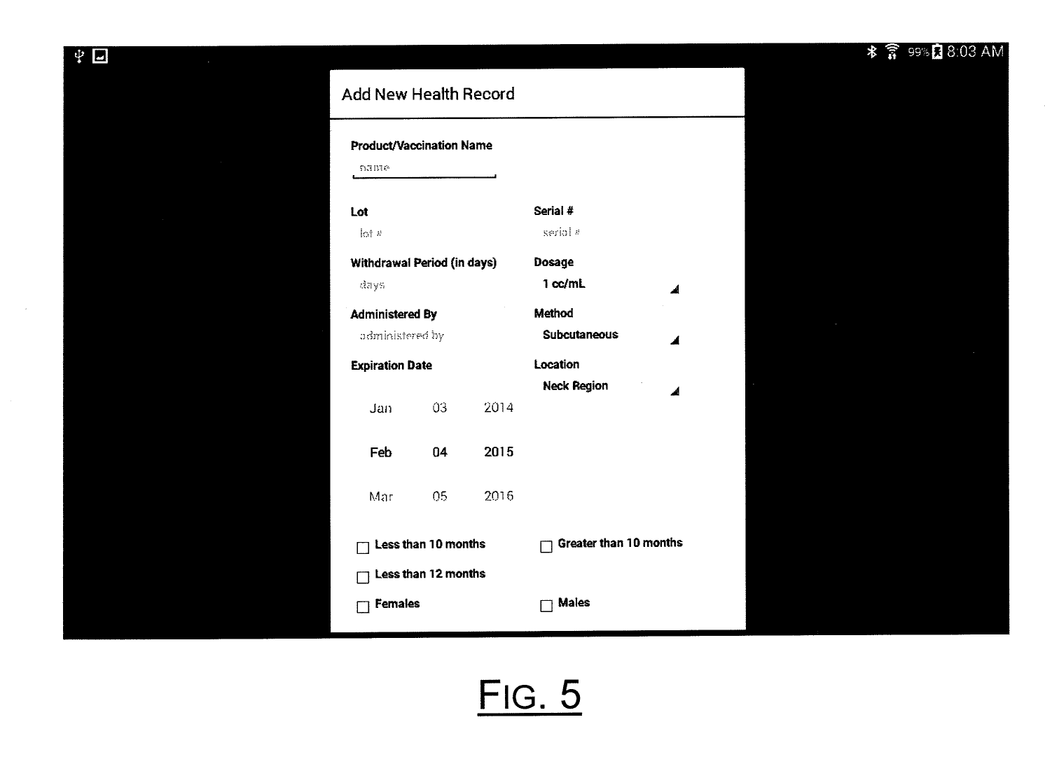

Turning to FIG. 5, the “Health—Vaccinations” screen shows what the customer sees when adding a new vaccination or other health record for a specific animal. At the top of the popup, the text “Add New Health Record” appears. Below that the customer can enter the name of the vaccination or other product, as well as the vaccination lot number and serial number. The main feature of the invention is that most of this information is autofilled. A user can specify a particular regiment of vaccinations to be performed during a session. Then as each head of cattle is weighed and vaccinated, the application will automatically ID the cattle, obtain and weight or other information available from wireless instruments, and update the vaccination chart with dates and other information. The customer can also enter in the withdrawal period, which is measured in days, as well as who administered the vaccine and when it expires. The customer can choose from a list of available options to show the vaccine dosage, method of vaccine administration, and where on the animal's body the vaccine was given.

At the bottom of the “Add Health Record” screen, the customer can check boxes for whether the animal is less than 10 months, greater than 10 months, or less than 12 months. The customer can also indicate whether the animal receiving the vaccine is male or female.

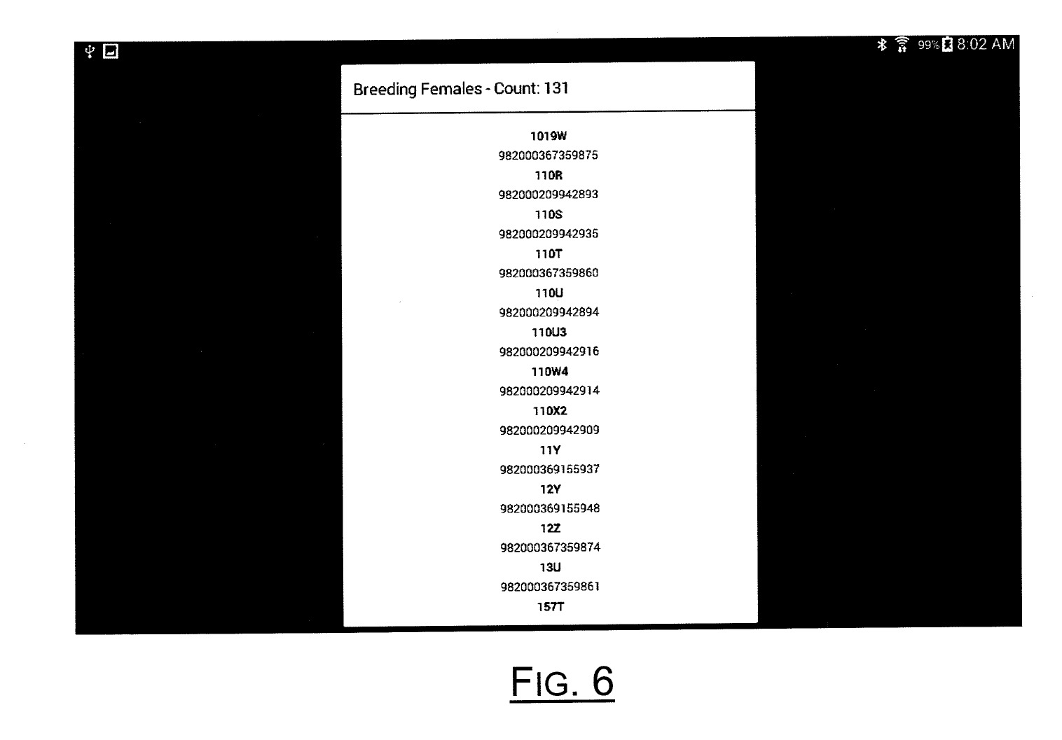

FIG. 6 shows a screen shot of the “Breeding Female List” section of the present invention. The top of the popup shows “Breeding Females” and gives a count of the total number of breeding females in the herd, in this illustration 131. Below the title the customer can see a scrollable list of each breeding female in the herd. The cows are listed by private herd number (PHN)/tattoo and electronic identification (EID). The PHN appears first in the list in bold font, followed by the EID in plain font.

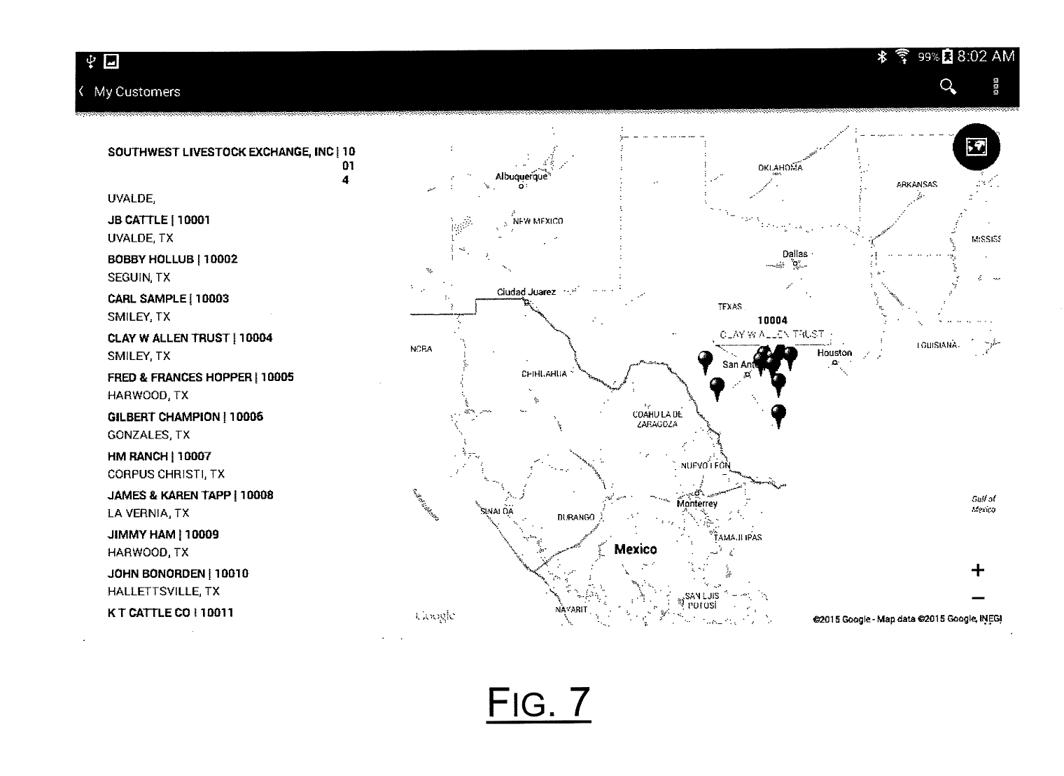

FIG. 7 shows the “Customer Map” screen of the present invention. The menu on the left of the screen shows a list of the customer's clients. The name of the client company and the assigned customer number appears in bold font, followed by the city and state in which the company is located listed in plain font.

On the right side of the screen is a Google map with markers on the locations of each of the customer's clients. When the customer selects a given marker, it will show the assigned number and name of the client. The customer can zoom in on the map to better see a cluster of clients, or zoom out to get a bigger picture of the locations of their total client base.

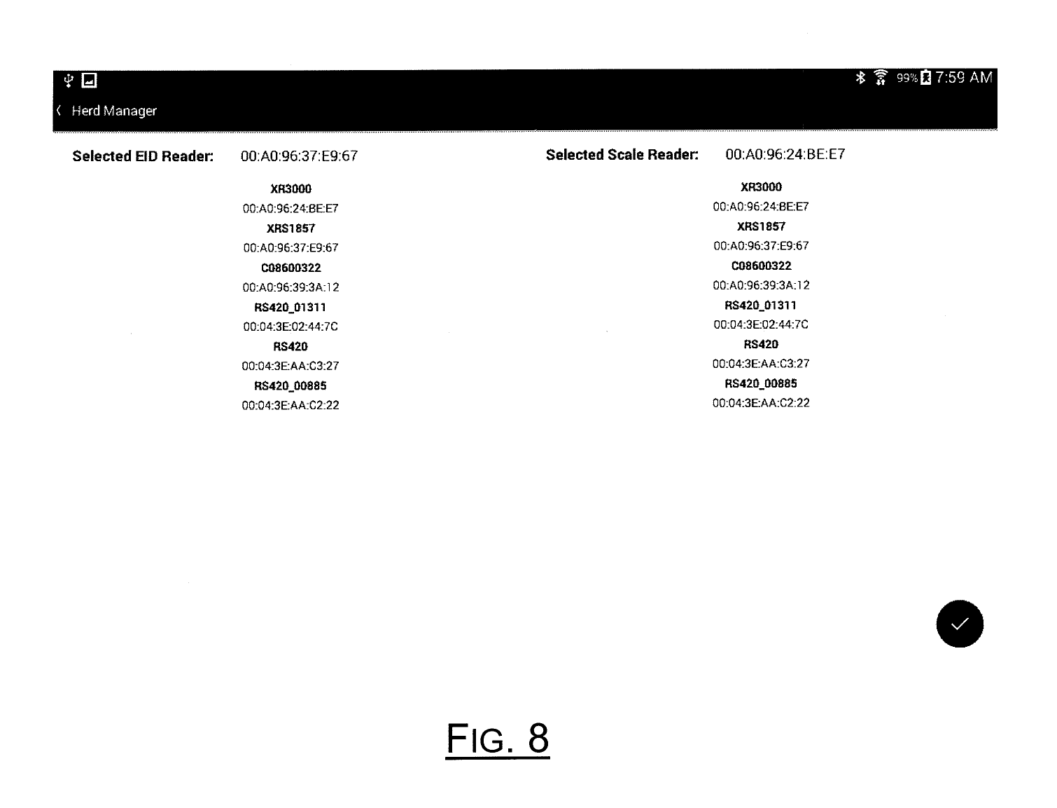

Turning to FIG. 8, the “Bluetooth Devices” screen shows lists of different types of devices that are connected to the app via Bluetooth technology. On the left is a list of electronic identification (EID) readers that can add data to the app. In some embodiments the MAC address of the wireless devices are also displayed to help with identification. On the right is a list of scale readers that report to the app. The devices that connect to the app via Bluetooth fill in data automatically, dramatically lessening the typing and manual input necessary to adding information to herd management software.

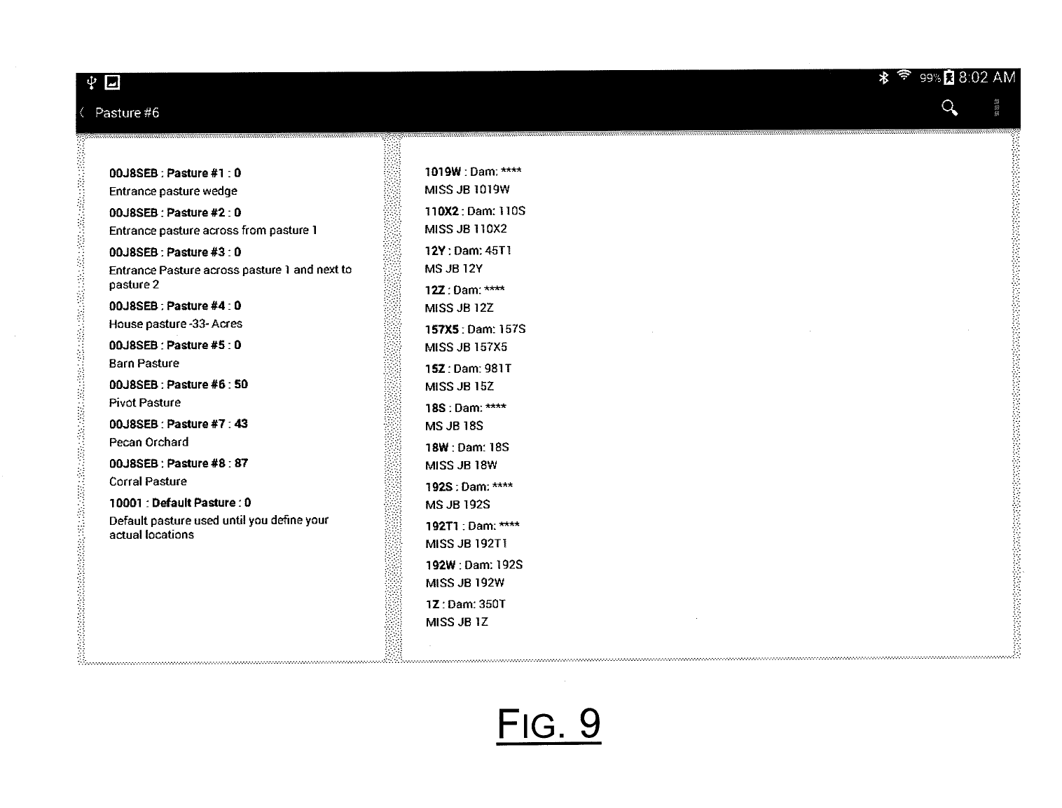

FIG. 9, a screen shot of “Pasture Inventory,” shows information about a specific pasture. This figure shows data on Pasture #6. On the left side of the screen is a list of all the customer's pastures. The name of the pasture appears in bold, and customized notes about each pasture appear in plain font. The customer can choose what details to add, such as where the entrance is located, or keywords to identify the pasture.

On the right side of the screen is a list of the cattle that are assigned to the current pasture. The private herd number (PHN) of each pasture resident is listed first in bold font, followed by the gender, and name of each bovine in plain font.

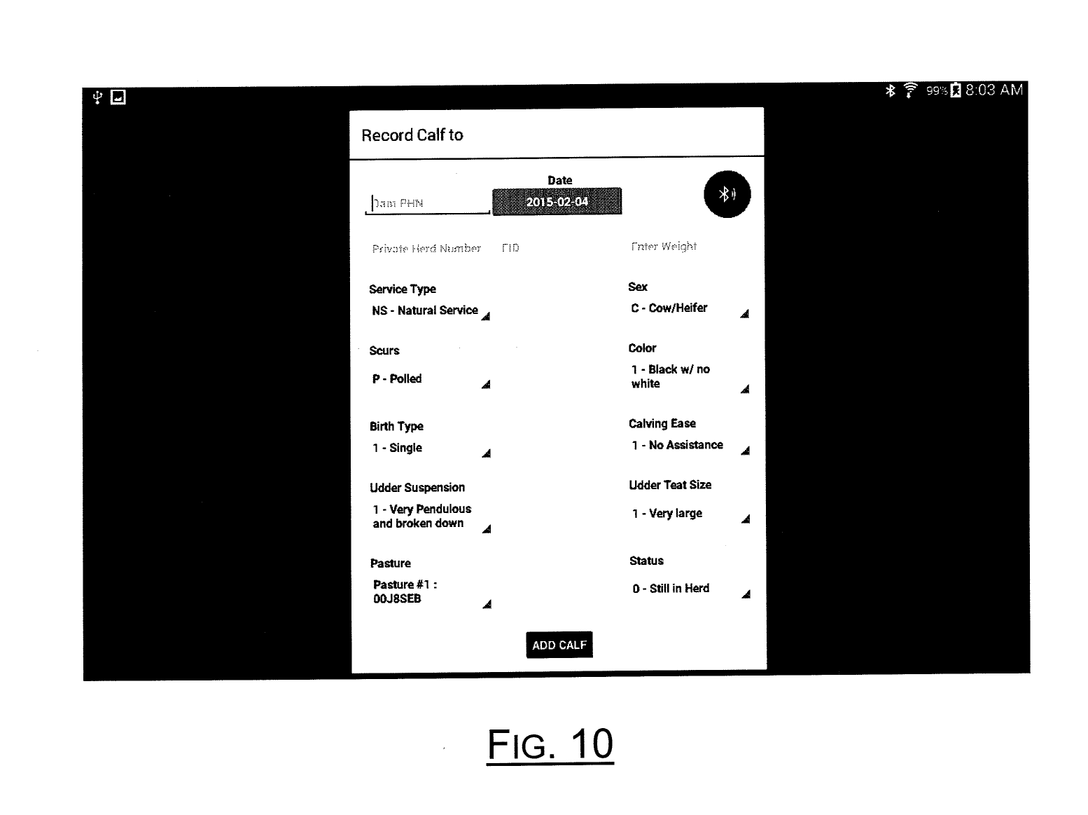

FIG. 10 shows the “Record Calf” screen, where the customer enters the record of a new calf added to the herd. The first field for entry is the dam's private herd number (PHN). The current date appears automatically. Below those entries, the customer can enter the calf's private herd number, electronic identification (EID), and weight. To fill in the information on the rest of the screen, the customer chooses from lists of predetermined options. The customer indicates the service type of the new calf, along with sex, scurs, and general color. Next the customer chooses the calf's birth type and the level of assistance the birth required (Calving Ease). The next line is where the customer indicates information about the udder, including suspension and teat size.

At the bottom of the screen, the customer selects the pasture the calf is assigned to, and the current status of the calf. When all the information is entered, the customer can then click the “Add Calf” button to add the new record to the herd.

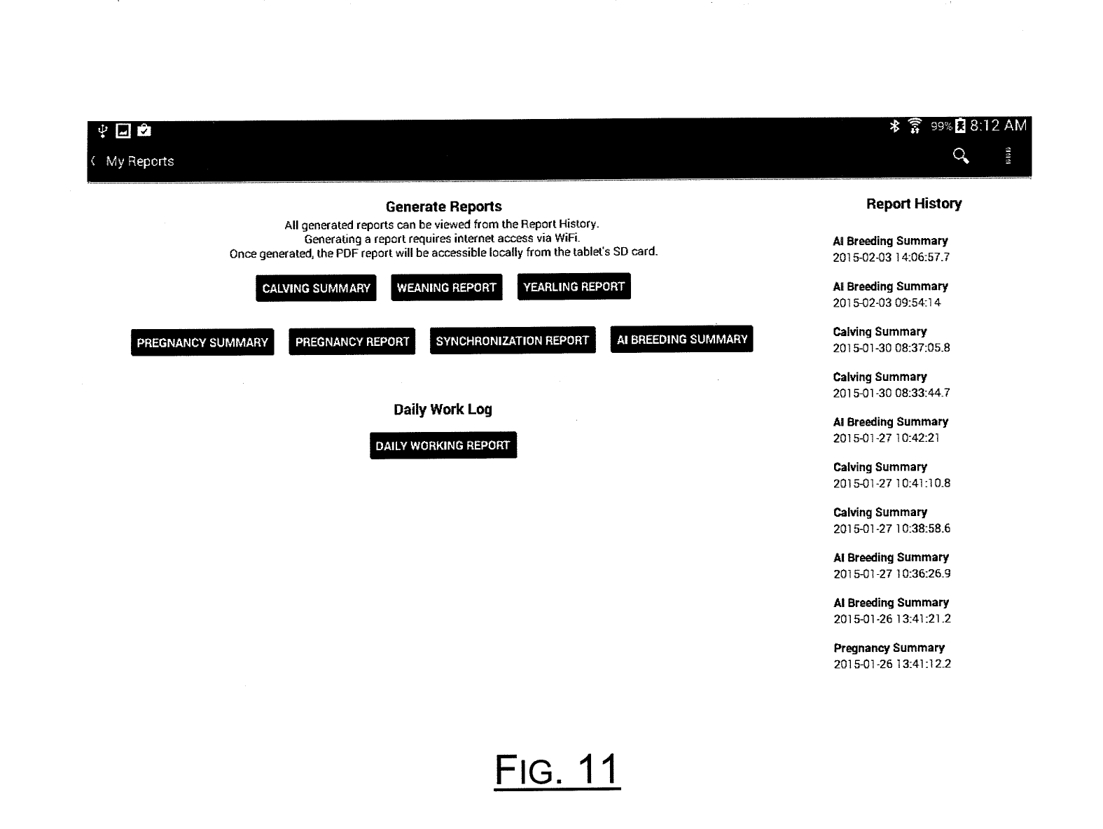

Turning to FIG. 11, the “Reports” screen is where the customer can generate new reports to view data about various aspects of the herd. While much of the app can be run offline, the customer must be connected to the internet via Wi-Fi to generate a new report. Reports that have already been created can be viewed offline. As indicated on the Reports screen, a PDF of each report is stored on the device's SD card.

The first report option available is a “Calving Summary.” This report gives an overview of the customer's calf-related data. The customer can generate a report about weaned cattle by choosing the “Weaning Report” option, or view a summary of data regarding yearlings by choosing the “Yearling Report” button. The next row of options allows the customer to view a summary of data relating to pregnant cows by choosing “Pregnancy Summary.” The “Pregnancy Report” button generates a report that offers more detailed information regarding pregnant animals. The “Synchronization Report” button generates a report of breeding synchronization of the herd. The “Al Breeding Summary” button generates a report that shows and overview of information and inventory relating to artificial insemination. Alternate embodiments can include a variety of different reporting options.

Under the heading “Daily Work Log” is the option to create a report of work done on a given date. The customer simply chooses the “Daily Working Report” to generate this report. On the right side of the screen is a list of reports that have already been created. The list is arranged by most recent creation. The name of the report appears in bold font, and the date and time the report was generated appear in plain font on the next line. To view past reports in PDF format, the customer can click on the report name.

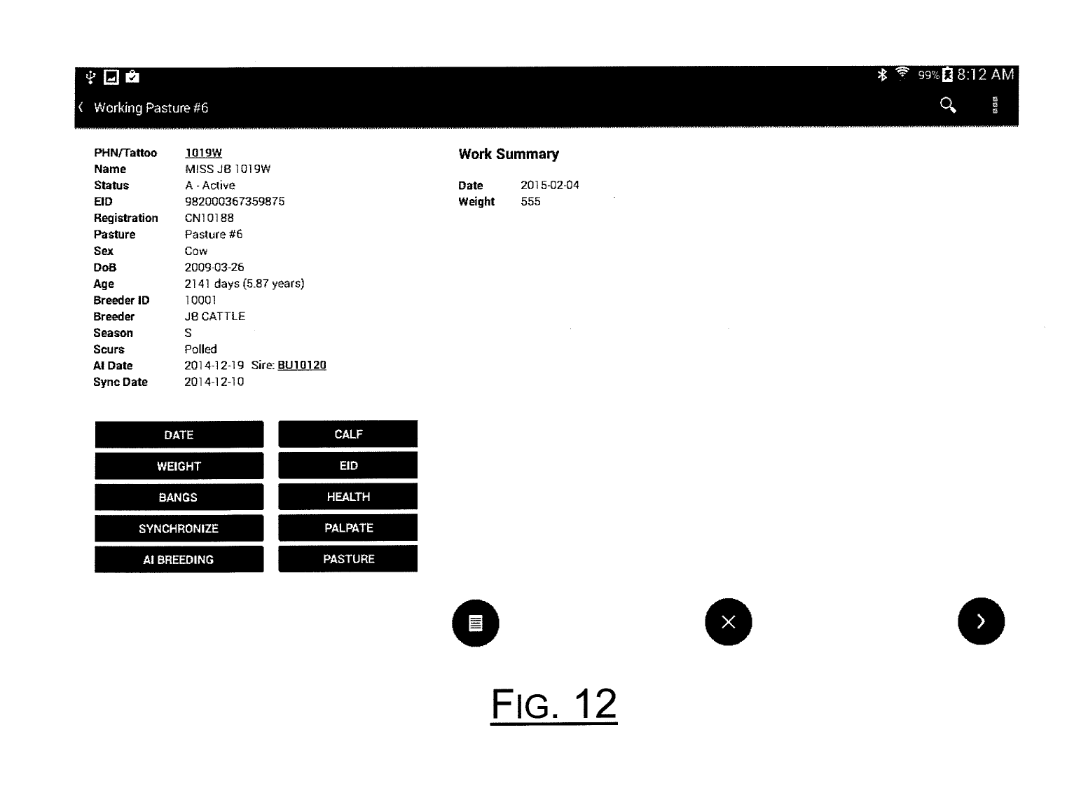

FIG. 12 is an image of the “Work Animal” screen of the present invention. It is accessed from the Pastures section of the application. The top bar shows the animal's pasture number. On the right side of the screen, the customer can see the animal's Work Summary, including date and weight. On the left is a summary of the bovine's identifying information. First is the private herd number (PHN)/tattoo, followed by name, status, electronic identification (EID), registration number, pasture, sex, date of birth, and age. The list also includes breeder ID, the name of the breeder, season, and scurs. The date of artificial insemination is listed, along with the name of the sire and a link to the sire's information. Lastly, the sync date is given.

Below the animal's information summary is a menu of options for adding and managing data about the animal. The “Date” button allows the customer to view the animal's data as of a particular day. The “Calf” button links to information about calves the animal has had. The “Weight” button allows the customer to add a new weight for the animal. When the customer chooses “EID,” they are linked to a screen where they can manage the electronic identification number. The “Bangs” button links to information about the animal's vaccines, and the “Health” button links to the section where the customer can manage health data related to the specific animal. By clicking the “Synchronize” button, the customer can synchronize all uploaded data about the animal across devices. The “Palpate” button links to pregnancy check information, and “Al Breeding” takes the customer to dates and data about past and current artificial inseminations. Lastly, the “Pasture” button shows information about which pasture the animal is kept in.

At the bottom of the screen are 3 buttons. The first button prints the record. The second button, which looks like an “X”, closes the screen. The button on the right moves to the next Work Animal record.

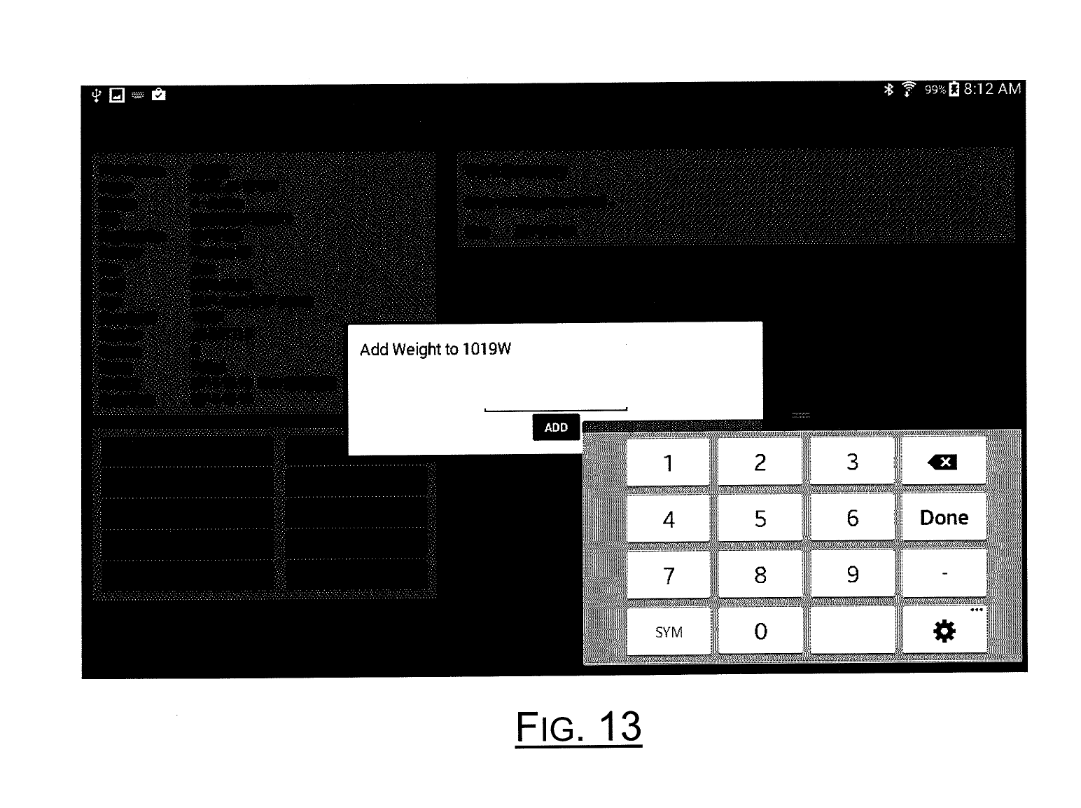

FIG. 13 is a screen shot of the “Work Animal—Add Weight” screen. This is what the customer sees when the “Weight” button is clicked on the “Work Animal” screen. A popup appears that says “Add Weight to [animal's name].” When the data field is clicked, a number pad pops up and the customer enters the appropriate numbers. Finally, the customer clicks the “Add” button to add the new weight to the animal's record.

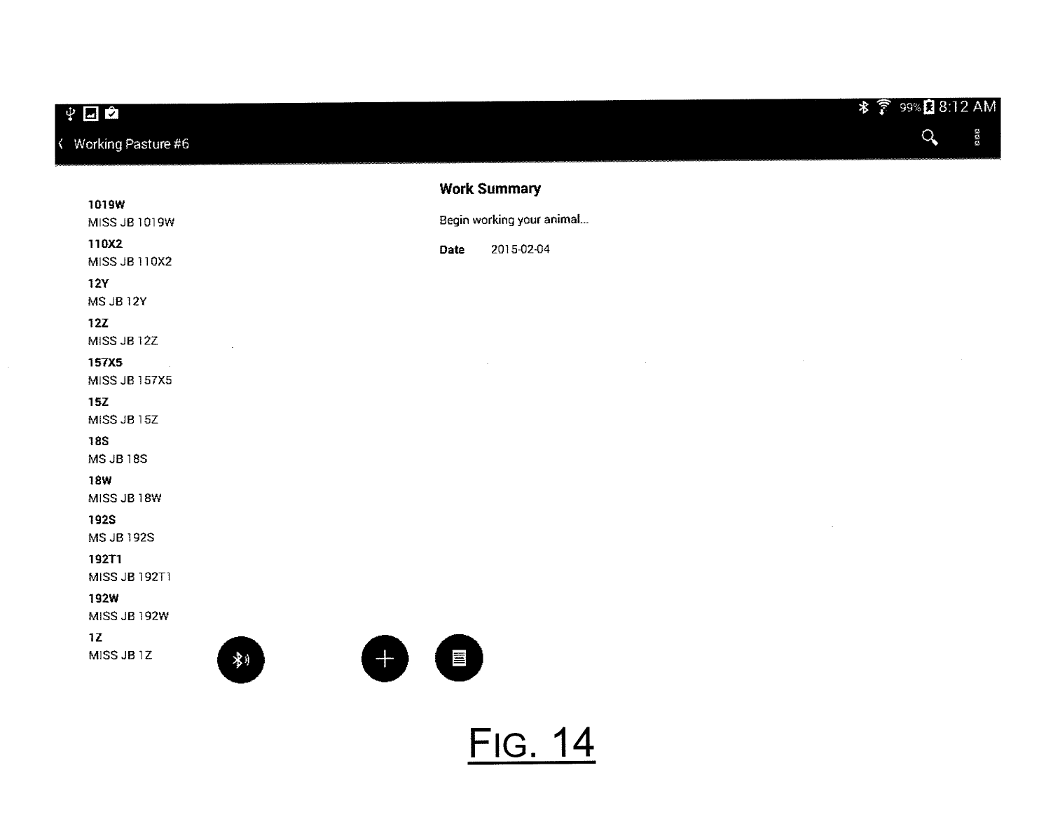

FIG. 14 shows the “Work Pasture” screen of the present invention. The bar at the top indicates which pasture the screen pertains to. The list on the left shows which animals are kept in the pasture, arranged by private herd number in bold font and name in plain font. On the right is a dated Work Summary for the pasture. The customer can select the Work Summary to add data.

What is claimed is:

1. A computer implemented method of herd animal management comprising:
a. providing a herd management application to a subscriber for installation on a handheld device;
i. the handheld device being adapted to interface wirelessly with a variety of data measuring devices;
b. receiving and automatically storing data from the variety of data measuring devices in a herd management database;
c. providing an interface whereby user of the handheld device can manually input a variety of data fields that the herd management application automatically records in the herd management database along with the data from the variety of data measuring devices;
d. synchronizing the herd management database with a server;
e. providing a herd management desktop interface;
f. generating variety of reports based on the herd management database.
